(19) United States
(12) Patent Application Publication
(10) Pub. No.: US 2013/0137059 A1
(43) Pub. Date: May 30, 2013

(54) SYSTEM FOR ABLATING MATERIAL IN THE ORAL CAVITY

(71) Applicant: Yong-min Jo, Dusseldorf (DE)

(72) Inventor: Yong-min Jo, Dusseldorf (DE)

(21) Appl. No.: 13/808,301

(22) PCT Filed: Apr. 12, 2011
(86) PCT No.: PCT/EP11/55742

§ 371 Date: Feb. 11, 2013

(30) Foreign Application Priority Data
Jul. 6, 2010 (DE) 10 2010 026 288.9

(51) Int. Cl. A61C 1/00; A61C 8/00

(52) U.S. Cl. CPC A61C 1/0046; A61C 8/0089
USPC 433/29

(57) ABSTRACT

The invention relates to a method for ablating solid material in the oral cavity, particularly jaw bone material. Known systems are disadvantageous in terms of precision and causing damage to the surrounding tissue. The object of the invention is to provide a system that allows for easy, safe, gentle, reliable and precise ablation. The object is achieved by the use of a fixation device, particularly a dental splint, and an insertion device that can be rigidly connected thereto and is particularly designed to introduce laser radiation and thereby ablate material, and that is in a fixed, predetermined position after having been connected.

### TECHNICAL FIELD

The present patent application relates to a system for ablating solid material inside the oral cavity of a patient.

### PRIOR ART

Solid material ablations (of bony and tooth material, old fillings or gum tissue) inside a patient's oral cavity are commonly achieved by drilling. Recently, it has become possible to handle such ablations also by means of needles or lasers.

Needles are only used therein to incorporate the tiniest holes into the jaw for the purpose of influencing tooth movement.

Laser radiation is used, for example, to remove gum tissue from the jaw bone, prior to drilling holes into the jaw bone. Bore holes of this type are common practice, for example, for fitting implants.

If such bore holes must be placed, the prior art envisions creating a master template prior to the placement of the bore holes, which is configured as a type of dental splint and indicates the target positions for the bore holes that were planned previously on the computer using x-ray and CT imaging techniques. Dental splints, which are usually manufactured of a plastic material, typically have metal-reinforced openings through which the drills can be introduced.

However, before drilling can commence, it is necessary to remove the gum tissue at the corresponding locations.

### BRIEF DESCRIPTION OF THE INVENTION

It is the object of the present invention to specify a system that is suitable for implementing solid material ablations inside the oral cavity, in a small number of work steps, as well as with a high level of precision and reliability.

This object is achieved by way of a system according to claim 1. Dependent claims 2 to 10 specify advantageous embodiments thereof.

A system according to the invention for ablating material inside the oral cavities of humans or animals comprises a fixation device and an insertion device. The insertion device therein includes at least one means for ablating solid material. The solid material to be ablated can be, for example, jaw bone or tooth material, dental fillings or gum tissue. For example, ablations can be done in preparation of a later incorporation of implants, dental fillings or inlays, anchoring of crowns and to create dental movement, for example, as part of a rapid orthodontic tooth movement therapy.

Conceivable means for touchless ablations are particularly laser beams or lasers, respectively, which are capable of generating such a beam. Other methods are also possible, in principle that can be used for ablating such materials. For example, the application of ultrasound, strong radio waves and the like are conceivable as well. Classic-type drilling is to be mentioned in this context as a method that is not touchless.

According to the invention, the fixation structure is configured such that the same can be fixed on a human or an animal head, particularly a jaw, for example a jaw bone, and/or on teeth. Possible for use in this context are, for example, dental splints and the like.

The fixation device includes a first connecting means, the insertion device a corresponding second connecting means, wherein the connecting means are configured such that the second connecting means can be rigidly connected to the fixation device. Furthermore, the fixation device and the insertion device are configured such that, after the second connecting means has been rigidly connected to the fixation structure that is fixed on the head, the second connecting means is in a fixed position relative to a jaw bone or a tooth in a human or animal. This means that the connecting means and/or the fixation device and the insertion device must be configured such that the fixation structure can be brought into a fixed position relative to the jaw bone or a tooth. This is possible, for example, by solidly and rigidly connecting the first connecting means to the fixation device and by rigidly connecting the second connecting means to the insertion device, and the connecting means are set up such that, when connecting the same to each other, they can be rigidly connected to each other. Conceivable means for achieving the rigid connection in this context are, for example, latching, clamping, sliding lock and/or magnetic alignment means. A rigid connection must not necessarily be solid. It is sufficient for a connection to be fixed in place upon, for example, exercising an upward pressing action relative to the alignment of the plane that is vertical in relation to the direction of pressure. This can be achieved, for example, by means of grooves and any corresponding protrusions. Advantageously, however, locking and/or fixation means are provided such that the connection is not only rigid but also solid in such a way that the same cannot be modified without actuation of deactivation means that must be provided, such as by retracting an interlock device, for example.

Using such a system, it is possible to achieve a fixed position of the insertion device. This way, the insertion device is able to apply the at least one ablation medium in a targeted fashion at a certain location.

This allows for carrying out any work steps with more precision, as they no longer depend on, for example, the optical guiding and applying of the ablation means by the physician. In addition, any said use is unaffected by, for example, possibly trembling hand movements, etc. Correspondingly, the system is able to implement a planned ablation measure with a visibly higher degree of precision. This improves, for example, the solidity of implants and reduces the quantity of the material that must be ablated for placing a dental filling.

A system of this kind can be used such that the fixation device is first placed in the head region of the patient, particularly on the patient's jaw, after which step the insertion device is fixed thereto via of the connecting means. Subsequently, it is possible to implement the ablation.

Advantageously, the insertion device is set up such that the insertion device or an end portion of the insertion device, which is directly adjacent to the second connecting means, is connected to the second connecting means in such a manner that the insertion device or the end portion thereof, respectively, includes a non-variable distance in the direction of the ablation relative to the structure in which the ablation is implemented. The direction of the ablation therein is the mean direction of incidence of the touchless ablation means. When incorporating a hole, the insertion device or the end portion of the insertion device, respectively, would thus be immovable in the insertion direction of the hole, meaning in the direction of the longitudinal axis thereof.

Advantageously, the insertion device or the end portion thereof, respectively, is only able to rotate around the direction of the ablation, particularly the longitudinal axis of the hole, meaning the insertion direction of the hole, and it is otherwise rigidly connected to the second connecting means. In addition, position-detection means are advantageously provided for detecting the precise position of rotation. In another embodied example, the end portion can be completely rigidly connected to the second connecting means. In this instance, no position-detection means are provided.

The end portion advantageously includes at least one redirection means for diverting the means for the touchless ablation. Preferred therein is a redirection by 60 to 120°, particularly 90°. The redirection means therein is advantageously positioned on an axis through the direction of the ablation.

Using such a redirection means, it is possible to provide an insertion device that is especially easy to position inside the oral cavity, an area offering only a limited amount of space, particularly perpendicular relative to the masticatory surfaces.

Advantageously, the fixed position according to claim 2 is a position that is predetermined by the fixation device and the connecting means.

With an embodiment of this kind, it is possible, for example, to obtain first a CT image or another type of imaging of the situation inside the oral cavity or of a part thereof (for example, by way of intraoral scanning or the like); ablation planning can be devised, for example, on the computer. It is then possible to create a fixation structure, for example, using a rapid prototyping process. The fixation structure therein can be adjusted to the shapes encountered in the oral cavity and include a first connecting means, which is provided in a predetermined position and aligned in a predetermined direction, such that it is possible to fasten the insertion device by means of the connecting means thereto; with the aid of the ablation means, it is now possible to implement an ablation that is, for the most part, compliant with the previously planned ablation. Accordingly, it is possible, for example, to create a corresponding computer program that represents images taken of the oral cavity, thereby allowing for a planning action of the ablation. The same could, furthermore, be set up such as to create a fixation device using corresponding means that are set up such that, subsequent to the same and after fixation of the fixation device and connection of the insertion device to the fixation device, an automatic ablation can be implemented, which is, for the most part, compliant to the previously planned ablation.

In the alternative to a predetermined fixed position of this kind, it would be conceivable for the fixation device and/or the insertion device to include at least one position-detection means for detecting the fixed position. A position detection of this kind is advantageously implemented relative to the fixation device. If the fixation device has a predefined position relative to the jaw and/or teeth, using the position-detection means, it is possible to detect the position of the insertion device relative to the structure of the jaw and/or the teeth. The above is conceivable such, for example, that the connecting means create a fixation that allows for rotation around an axis. This is advantageous, for example, in order to have the ability of placing an insertion device as freely as possible inside the oral cavity.

The corresponding method would then include the step for detecting the position of the insertion device that is to be implemented prior to the ablation.

Advantageously, a dental and/or jaw splint is advantageously used as a fixation device for the positive clamping action onto a jaw portion and/or teeth and/or implants. This offers an especially easy and reliable fixation option.

Especially advantageously, a means for ablation is connected to a pulsed laser or a light guide that is connected to a pulsed laser.

Pulsed lasers are particularly expedient for a gentle ablation. The insertion device therein is set up such that it uses a laser beam for ablating solid material inside the oral cavity. The use of pulsed lasers is especially advantageous, as it helps to prevent carbonification of a jaw bone structure and keeps the heat input to a comparatively minimal level.

The connecting means are advantageously selected such that the connection is water-proof. Correspondingly, germs cannot penetrate the oral cavity via saliva.

The connecting means are advantageously selected such that no particles or liquids are able to penetrate the insertion device. This allows for easy use of the insertion device in different patients. To this end, the device would only have to be disinfected from the outside and/or provided with a replaceable coating.

The touchless ablation means therein, for example a laser, must not necessarily be positioned inside the oral cavity. Rather, it can be remotely positioned and guided into the oral cavity by means of a transportation means such as, for example, a light guide.

Particularly advantageously, the insertion device includes a scanner, particularly when a pulsed laser is used as an ablation means. A scanner is generally advantageous for the controlling and/or deflecting action and particularly the scanning motion of the ablation means or the location of action and/or incidence, respectively, of the ablation means.

A scanner of this kind contains, in particular, at least one motion device that has attached thereto particularly a scanner mirror. By targeted triggering of the motion device, it is possible, for example, to controllably deflect the laser beam.

To be able to use the information regarding the fixed position further for the purpose of directing, for example, the laser beam in a targeted fashion to the planned location, it is advantageous for the motion device to be rigidly connected to a second connecting means. In the alternative, it is possible to dispose the scanner without any such rigid connection as well. Furthermore, for obtaining the information, it is possible to provide at least one sensor that, for example, detects any changes and/or changes as to position and/or alignment. In the alternative or in addition, it is possible to provide means that ensure an identical location of incidence and/or action even also in the event of changes as to the position and/or alignment. This is possible, for example, owing to the use of special optics that are coupled to the moved and/or unmoved parts. The same can also be ensured by the use of light guides on the moved parts and/or joints and/or adjustment locations, when the scanner changes the launch direction relative to the light guide, for example.

The use of a plurality, particularly two motion devices with respectively one scanner mirror, is especially advantageous because in that case the laser beam can be deflected in different planes. By such a deflection, it is possible to direct the laser beam in a targeted fashion to different points while engaging only in very localized ablation work. This allows for reducing the thermal input and for implementing a particularly planning-compliant ablation. For example, if the goal is to create a hole, the laser beam can be guided in different patterns over the area where the hole is to be created. This way, it is possible for the locations that are presently not exposed to the laser beam to cool down in the interim. Moreover, it is also possible to achieve an especially vertical hole shape. Contrary to commonly used methods involving drills, it is also possible to achieve any geometrical layout for the hole such as, for example, a hexagonal shape. A corresponding method would thus entail the method steps in the context of an ablation of activating the pulsed laser and directing the laser beam by means of the control of the motion device such that an ablation is implemented at the desired positions resulting ultimately in the embodiment of the planned ablation.

Especially advantageously, the insertion device can include an end portion that is, in particular, rigidly connected to the second connecting piece. A deflecting mirror is disposed inside an end portion of this kind and fixedly connected to the same. The end portion, in turn, is rigidly connected to the scanner. A launch portion for launching laser pulses is, in particular, movably connected to the scanner, which is, in particular, movably connected to the laser. Accordingly, using the launch portion, a laser pulse can be launched in the scanner, correspondingly deflected by the scanner mirror and subsequently guided to the predetermined location by means of the fixed deflecting mirror. The use of a deflecting mirror of this kind in an end portion, in addition to the scanner, allows for the possibility of disposing the scanner at a somewhat more remote location relative to the connecting means and the hole expansion at an angle, allowing for a flatter construction and, consequently, more comfort during use in the oral cavity.

Especially preferred is a system that is configured and/or used for incorporating at least one hole in a jaw, particularly with an angular cross-section. A configuration of this kind can be characterized by a corresponding computer system for planning and implementation, the ablation means such as, for example, the laser energy or laser pulse form, the type of the scanner or the connecting means. Angular holes are particularly advantageous because they allow for achieving an especially secure hold such as, for example, for implants. Accordingly, a system is particularly advantageously configured for inserting a fastening structure for an implant into a jaw bone. A corresponding use highlights the advantages of this system with special acuteness.

In the alternative, it is possible to advantageously configure and/or use such a system for inserting a hole or a recess into a tooth. A configuration of this kind can be characterized by a corresponding computer system for planning and implementation, the ablation means such as, for example, the laser energy or laser pulse form, the type of the scanner or the connecting means. Using such a system, it is possible to incorporate holes or recesses with special precision, such that the hold of fillings possibly to be incorporated is especially secure and the quantity of the material that must be ablated is very minimal.

For example, a more complex scanner is required for deep holes than for removing superficial and decayed tooth material.

In the alternative, a system of this kind can also be advantageously configured and/or used for ablating jaw bone in the direct vicinity of the tooth with the goal of influencing the movement of a tooth in the jaw such as for correcting a tooth misalignment. Said correction can be achieved, for example, in the context of a rapid orthodontic tooth movement therapy. A configuration of this kind can be characterized by a corresponding computer system for planning and implementation, the ablation means such as, for example, the laser energy or laser pulse form, the type of the scanner or the connecting means. In contrast to the removal of surface and decayed tooth areas, when it is typically possible to direct the ablation means coming from above onto the tooth, for an application of the former kind, the scanner and/or connecting means must be set up such that they are able to guide the ablation means directly to the region of the jaw that is adjacent to the tooth; indeed, frequently this is the interdental space.

The systems are advantageously connected to the corresponding control software and hardware that will ideally also allow for the planning of an orthodontic intervention and include interfaces to this end, respectively.

The insertion device advantageously contains a distance-measuring device. Using such a distance-measuring device, it is possible, for example, to detect the distance relative to the material that is to be ablated. This allows for detecting the success of the ablation and/or the depth, or also the shape of the ablation. The result is an even more precise implementation of the ablation because corresponding feedback is made possible.

A distance measurement of this kind can be accomplished, for example, via a triangulation means that is used for implementing a distance measurement using laser triangulation. Possible for use therein is a guidable laser beam that is used for the ablation as well as presently, although at a lower intensity, if necessary, for measuring the implemented ablation and/or the type of material that is present at the ablation location.

In the alternative or in addition, it is possible for such a distance-measuring device to include means for detecting an ablation noise. A microphone, for example, is suitable for this purpose. For example, if material is ablated by means of a laser beam, plasma and an ablation noise are generated. Said ablation noise can be detected. This is possible in various ways. A distance measurement of this kind has the advantage that it is taken simultaneously with the ablation. Measuring the hole geometry and/or the ablation shape and/or the material that is present at the location of the ablation is thus possible. In contrast to laser triangulation, it offers the advantage that it supplies relatively precise results; even if comparatively high volumes of vapor or particles are present at the ablation location.

Such a measurement can be taken by determining the reflection time of the sound waves of the ablation noise that can be converted, based on the speed of sound between ablation location and microphone, into a distance between location or origin (ablation location) and receiving microphone. The generation of the ablation means can be used therein as starting point for the measurement of time; for example, this can be the laser pulse or the passage of the ablation means, for example of the laser pulse, through the insertion device because, the reflection time of a laser beam can typically be neglected, for example. Thus, it is possible, for example, to measure a depth change between two measurements that occurs due to an ablation action. The above applies provided that the position of the insertion device or at least of the microphones has not changed in the meantime with regard to the distance relative to the structure in which the ablation is being conducted. Said goal can be achieved by a configuration of the insertion device as described above and/or by means of the rigid connection of the microphones to the second connecting means. Furthermore, upon commencing with the ablation, it is possible to detect the distance relative to the structure that is to be ablated.

In the alternative, if at least two microphones, disposed asymmetrically relative to the ablation location, or at least three microphones are used, a distance determination is possible even without any knowledge regarding the time of origin. By a calculation based on the individual reflection times, particularly using the knowledge regarding the direction of incidence of the ablation means, it is possible to detect a distance in a known and easy manner by means of trilateration.

Using at least two microphones, it is possible, conducting the calculation based on the reflection times relative to the at least two and/or three microphones, to obtain a check of the control of the laser beams. In fact, with a simple calculation based on the reflection times, it is possible to calculate the location of origin.

Furthermore, by detecting the ablation noise, it is possible to draw conclusions as to further properties of the ablation material and/or the material in the vicinity of the ablation. Correspondingly, it is possible, for example, to arrive at a rough volume determination relative to the material that is still present or regarding the solidity of the ablated material. This allows for a very effective controlling action of the ablation.

By detecting the ablation noise, using a laser as means of ablation, it is possible to determine the necessary laser and/or pulse energy. The same can differ depending on the jaw bone or the substance that is to be ablated. For example, the laser energy can be slowly increased until an ablation noise is detected. This way, it is possible to adjust the required laser energy very precisely adjusting the same to the individual points of the ablation, thereby achieving an especially gentle ablation while minimizing the thermal input.

The insertion device, provided the same contains as a means for ablating a pulsed laser or light guide that is connected to a pulsed laser according to claim 4, advantageously comprises means for detecting the ablation noise as well as means for detecting the time delay between the generation or the passage of a laser pulse through the insertion device and the detection of the ablation noise. This allows for the implementation of an especially reliable and precise distance measurement. The reflection time of the laser beam therein can typically be neglected.

A focusing device is advantageously provided in, on or adjacent to the insertion device. Using such a focusing device, which comprises particularly two or more lenses, it is possible to focus the laser beam, particularly at the location where the ablation is to take place. The focusing device is advantageously set up such that the focus can be shifted and, in particular, tracks the course of the ablation. This is especially advantageous for deep ablations in order to ensure that the full intensity of the ablation means is always available and focused on the ablation location. Tracking therein can be oriented on the planned, calculated and/or measured and already completed ablation and/or the depth of the planned, calculated and/or measured ablation location.

Advantageously, the fixation device can have positioned thereon or therein devices for cooling, particularly for supplying and, if necessary, drawing off a cooling agent. The cooling means supply therein can be provided, for example, via a nozzle for the targeted supply of a cooling agent. Conceivable as a suitable cooling agent is, for example, cooled water, or ice water. Optimally, the selected cooling agent will allow a laser beam to pass without influencing the same, in as much as possible. A suction channel can be provided for drawing off the cooling agent. It is possible to connect, for example, suction means that are customarily available in any dental office. However, it is conceivable to provide a cooling agent that evaporates, for example, thereby being able to exit automatically through a corresponding opening and/or being transported to the outside in the cooling agent flow.

Conceivably, the devices for cooling can be envisioned on the insertion piece.

Thus, a corresponding method would comprise the steps:

a. providing or preparing a fixation device, particularly based on the imaging materials taken of the oral cavity;
b. fixing the fixation device in place in the head region, particularly in the jaw or teeth area;
c. connecting the insertion device to the fixation device by means of the connecting means;
d. application of the ablation means for ablating the material.

Advantageously, the ablation operation is planned in advance. It is especially advantageous for the ablation to be implemented by means of a scanning-type method that provides for the ablation to be always only implemented at small points, whereby the planned or desired ablation is accomplished gradually. Taking distance measurements is especially advantageous for optimizing the ablation; for example, to achieve more precision in terms of control of the ablation with regard to energy and focus and/or to compare, for example, the expected ablation with the achieved ablation, as well as adjust the ablation action correspondingly. It is especially advantageous for additional data to be gathered based on the evaluation of the ablation noise, which can also be utilized for optimizing the ablation.

### BRIEF DESCRIPTION OF THE DRAWINGS

Further advantageous embodiments as well as further benefits of the invention shall be described based on the schematic drawings.

Shown are in the figures in detail as follows:

FIG. 1 is a schematic overview of the application of the system inside the oral cavity;

FIG. 2 is a schematic overview of a system according to the invention;

FIG. 3 is a schematic representation of the functionality of the system according to the invention;

FIG. 4 is a schematic representation as in FIG. 3, but with cooling means; and

FIG. 5 is a schematic representation of a distance measurement;

FIG. 6 is a schematic overview of a second system according to the invention; and

FIG. 7 is a schematic overview of a third system according to the invention.

### WAYS(S) TO EMBODY THE INVENTION

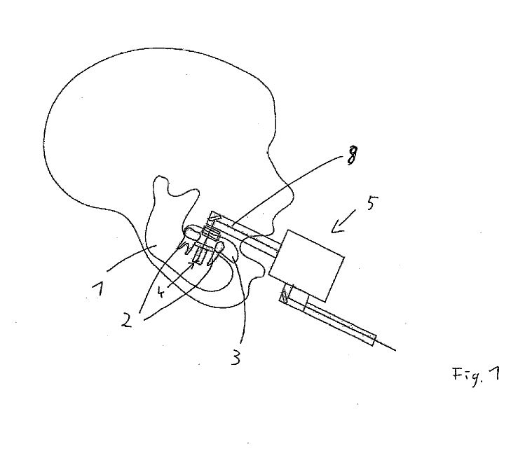

FIG. 1 shows a human head with a jaw 1. FIG. 1 includes two depicted teeth 2. Furthermore, also shown is a hole 4, and laser beam 8 is directed upon the base of the same. The laser is introduced using a handpiece 5. The handpiece 5 therein can be held by the physician or user, respectively. Being held means merely that the weight of the handpiece is supported by the physician. The precise alignment of the handpiece 5, or at least that of an end portion, is determined by a dental splint 3 and the connecting means. Using laser beam 8, the hole 4 is created by ablation from the jaw bone. A dental splint 3 is applied to these two teeth 2 and serves to fasten and/or align the handpiece 5.

A system of this kind can be used to create a hole 4 in a targeted manner.

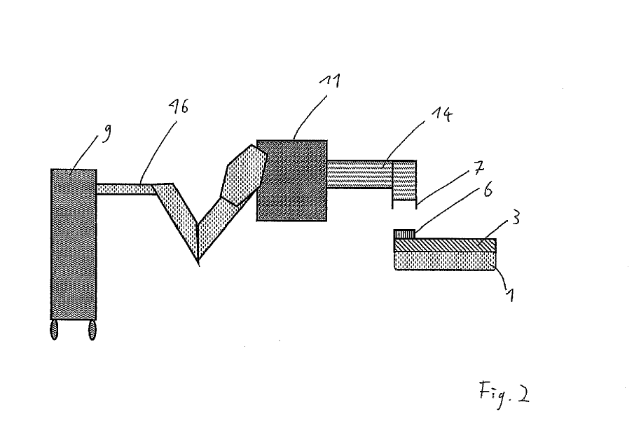

FIG. 2 is a schematic representation of a system according to the invention, wherein the dental splint 3 is applied to a jaw 1 that is not part of the system. The observer recognizes a first connecting element 6, which is solidly and rigidly connected to the dental splint 3. A second connecting means 7 is solidly and rigidly connected to the end portion 14. The same, in turn, is solidly and rigidly connected to the scanner 11. Scanner 11, however, is movably connected to a launch portion 16, which opens up into a laser 9. In this example, laser 9 is disposed in a large movable housing launching the laser pulses thereof in the launch portion 16, which is movable multiple times in itself and guides the laser beam. When the laser beam exits the launch portion 16 and enters the scanner 11, it can be deflected therein. The laser beam then enters an end portion 14, where it is redirected in the direction of the jaw 1. The jaw material can be ablated at that location.

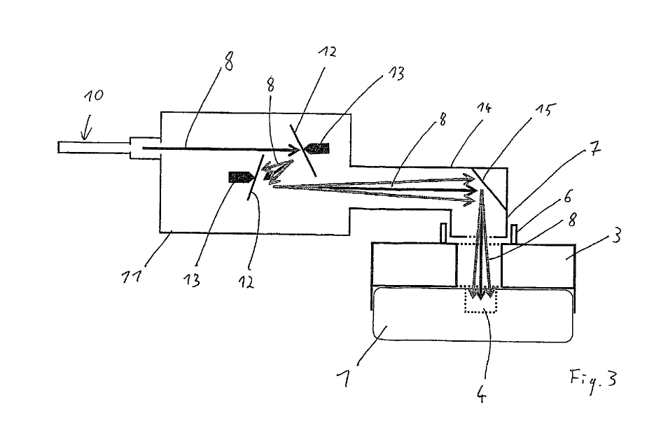

FIG. 3 is a cross-section of the system according to the invention. Furthermore, also shown is a jaw 1. A dental splint 3 is placed onto the jaw 1, which is fastened at that location by means of a positive fit. The dental splint 3 includes a first connecting means 6 that engages with a second connecting means 7. An end portion 14 and a scanner 11 are fixedly connected to the second connecting means 7. For the launch of a laser beam 8, scanner 11 has a light guide 10 into which a pulsed laser, which is generated in a laser, is launched as laser beam 8 into scanner 11. Located inside scanner 11 are two scanner mirrors 12, which are fastened each on a motion device 13. Said motion device 13 is computer-controlled and allows for deflecting laser beam 8 in different directions and planes. This is indicated by a plurality of laser beams 8 depicted in different shades of grey. Laser beams 8, which are deflected in this manner, are incident in end portion 14 upon a fixedly disposed deflecting mirror 15 and are thereby redirected in the direction of the jaw 1. This is how they ablate jaw material and create hole 4.

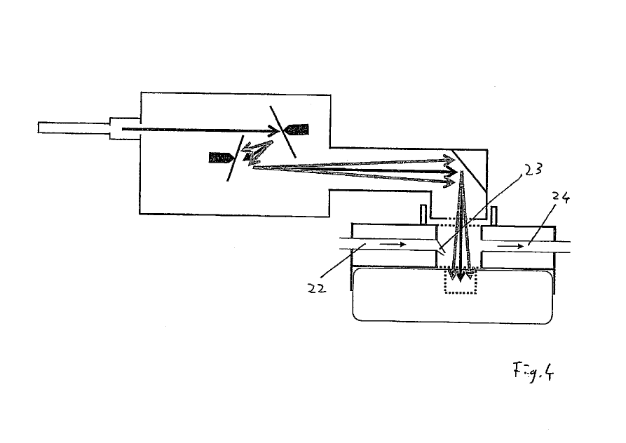

FIG. 4 shows the representation from FIG. 3, but with a cooling agent supply channel 22, a cooling agent nozzle 23 and a suction channel 24. Channels 22, 24 include the corresponding hook-ups on the outside for connecting a supply and/or suction means. The nozzle 23 directs the jet of cooling agent upon the location where the ablation occurs. The flow direction of the cooling agent is illustrated by the arrows.

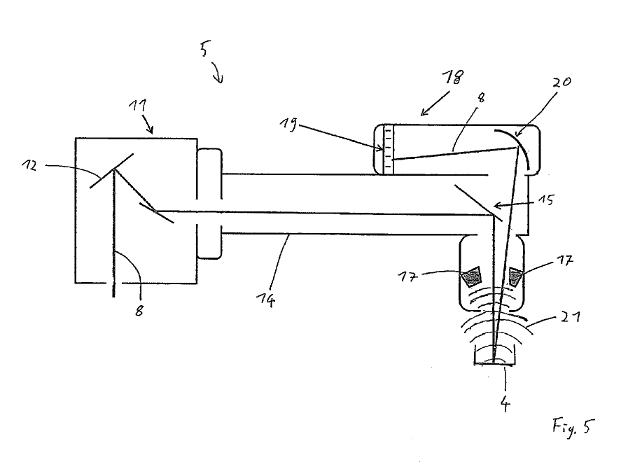

FIG. 5 shows the handpiece 5. The connecting means and the dental splint therein are not depicted. The laser beam 8 is launched via scanner 11 and the scanner mirror 12 thereof as well as via deflecting mirror 15 into the hole 4. There, the beam is partially reflected and subsequently redirected via a triangulation mirror 20, which is disposed in an additionally mounted triangulation arm 18, to a CCD 19. By the displacement of the laser beam 8 on the CCD 19, it is possible to detect the change relative to the depth of the hole 4. Advantageously, a laser beam 8 is used therein, which does not result in an ablation. By the movement of the scanner mirror 12, it is possible to move the laser beam 8 inside hole 4. This way it is possible to detect the depth and/or the change in depth of the hole 4 at different locations. When the energy of the laser beam 8 is increased, which causes an ablation to occur, there results an ablation noise 21, which is indicated by wave fronts. Said ablation noise 21 hits the microphones 17 and is detected by the same. This way, it is possible to gather information as to the structure on which the ablation noise 21 has occurred. Moreover, if the point in time is known, when laser beam 8 arrives in hole 4 and/or passes the handpiece 5 or is generated outside of the handpiece 5, it is possible to determine the depth of the hole 4 and/or the distance of the base thereof relative to the microphones 17. Knowledge as to the exact time of when the beam arrives at the base of the hole 4 is not required, because the reflection time of laser beam 8 is minimal in relation to the reflection time of the acoustic waves of the ablation noise 21 and can be neglected.

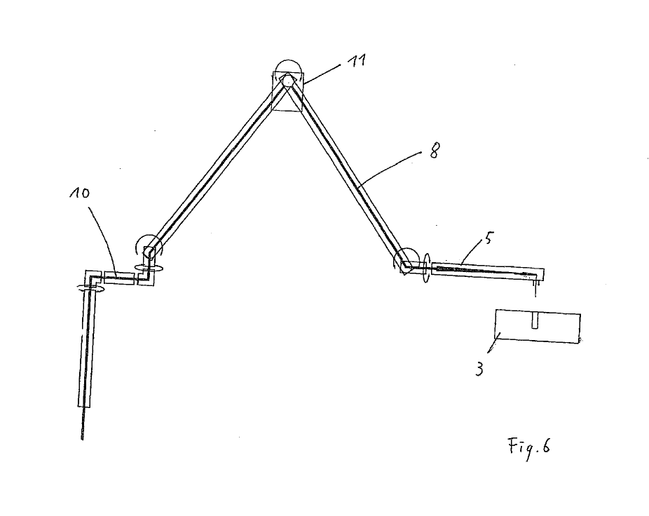

FIG. 6 is a schematic representation of a second system according to the invention having a movable arm for guiding the laser beam 8. The arm in part includes light guides 10. A scanner 11 is disposed inside the arm. The arm can be rotated or bent at a plurality of locations. These degrees of freedom are indicated by arrows. A handpiece 5 is disposed on and connected to the arm. Dental splint 3 is also shown.

An embodiment with a movable arm is associated with numerous benefits for the practical application inside the oral cavity.

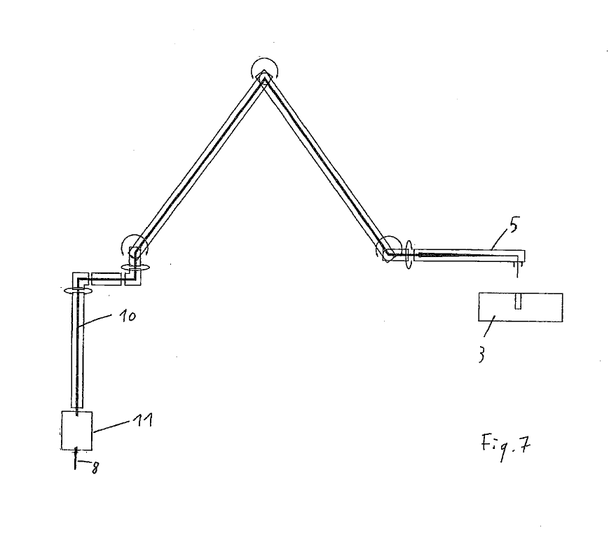

FIG. 7 is a schematic representation of a third system according to the invention similarly to FIG. 6, wherein a scanner 11 is disposed at the base of the arm.

Further advantageous embodied examples can be easily devised by the person skilled in the art and, if necessary, adapted to the respective requirements.

### LIST OF REFERENCE SIGNS

1. Jaw
2. Tooth
3. Dental splint
4. Hole
5. Handpiece
6. First connecting means
7. Second connecting means
8. Laser beam
9. Laser
10. Light guide
11. Scanner
12. Scanner mirror
13. Motion device
14. End portion
15. Deflecting mirror
16. Launch portion
17. Microphone
18. Triangulation arm
19. CCD
20. Triangulation mirror
21. Ablation noise
22. Cooling agent supply channel
23. Cooling agent nozzle
24. Suction channel

1. A system for ablating solid material in the oral cavity of a human or an animal comprising:
a fixation structure and an insertion device, wherein the insertion device includes at least one means for the touchless ablation of solid material and the fixation device is set up for fixing the same in place on a human or animal head wherein the fixation device includes a first connecting means and the insertion device includes a second connecting means, wherein the connecting means are set up such that the second connecting means is rigidly connected to the fixation device, and wherein the fixation device and insertion device are configured such that the second connecting means, following the connecting action to the fixation structure that is fixed on the head, is in a fixed position relative to a jaw bone or a tooth of a human or animal.

2. The system according to claim 1, wherein the fixed position is a position that is predetermined by the fixation device and the connecting means.

3. The system according to claim 1, wherein the fixation device comprises a dental and/or jaw splint for clamping upon a jaw portion and/or teeth and/or implants.

4. The system according to claim 1, further comprising at least one means for touchless ablation.

5. The system according to claim 4, wherein the insertion device comprises a scanner for deflecting the at least one means for touchless ablation.

6. The system according to claim 5, wherein the scanner comprises at least one scanner mirror that is fastened to a motion device for the controllable deflection of the laser beam.

7. The system according to claim 6, wherein the motion device is rigidly connected to the second connecting means.

8. The system according to claim 1, wherein the insertion device comprises a scanner, which comprises at least one scanner mirror that is fastened to a motion device for the controllable deflection of the laser beam, and in that the motion device is rigidly connected to the second connecting means.

9. The system according to claim 1 for incorporating a hole in a jaw bone.

10. The system according to claim 1 set up for incorporating a hole or a recess into a tooth.

11. The system according to claim 1 set up for ablating jaw bone in the direct vicinity of a tooth for influencing the movement of the tooth inside the jaw.

12. The system according to claim 1 wherein the insertion device comprises a distance-measuring device.

13. The system according to claim 11, wherein the distance-measuring device comprises means for detecting an ablation noise.

14. The system according to claim 1 wherein the fixation device is set up for fixing the same in place on a human or animal jaw.

15. The system according to claim 4, wherein the at least one means for ablation comprises a pulsed laser or a light guide that is connected to a pulsed laser.

16. The system according to claim 9 wherein the hole is angular.

17. The system according to claim 9, wherein the hole incorporated in the jaw bone is for inserting a fastening structure for an implant in the jaw bone.

18. The system according to claim 13 wherein the distance-measuring device comprises at least one microphone for detecting an ablation noise.
